(19) United States
(12) Patent Application Publication
(10) Pub. No.: US 2024/0095290 A1
(43) Pub. Date: Mar. 21, 2024

(54) DEVICE USAGE MODEL FOR SEARCH ENGINE CONTENT

(71) Applicant: INTERNATIONAL BUSINESS MACHINES CORPORATION, Armonk, NY (US)

(72) Inventors: Zachary A. Silverstein, Georgetown, TX (US); Sonya Leech, Trim (IE); Lisa Ann Cassidy, Dublin (IE); Kelley Anders, East New Market, MD (US)

(21) Appl. No.: 17/948,562

(22) Filed: Sep. 20, 2022

(51) Int. Cl. G06F 16/9535

(52) U.S. Cl. CPC G06F 16/9535

(57) ABSTRACT

A computer-implemented method for filtering search engine results for a user is provided. The method includes maintaining a filtration layer that is opted into by a search engine and a client device. The method further includes building a user search interaction model, operatively coupled to the filtration layer, based on a user's profile and historic search results by performing a topic analysis on a user's interactions with the historic search results and selecting a subset of relevant topics based on respective amounts of user interaction. The user interaction includes interactions on a plurality of different devices. The method also includes filtering search results produced for a particular user search query on the client device using the user search interaction model and the filtration layer.

### BACKGROUND

The present invention generally relates to search engines, and more particularly to a device usage model for search engine content.

A user is highly specialized in a specific field. Relevant information about this field is mostly contained within a collection of certain internal or external web sites. When using a search engine to find specific data content, it is often the case that return results of the search engine do not relate to what the user has requested or the content returned is outdated and irrelevant. It is therefore necessary to build a solution that will alleviate the burden of having to do multiple searches to get the relevant most accurate up to date information.

### SUMMARY

According to aspects of the present invention, a computer-implemented method for filtering search engine results for a user is provided. The method includes maintaining a filtration layer that is opted into by a search engine and a client device. The method further includes building a user search interaction model, operatively coupled to the filtration layer, based on a user's profile and historic search results by performing a topic analysis on a user's interactions with the historic search results and selecting a subset of relevant topics based on respective amounts of user interaction. The user interaction includes interactions on a plurality of different devices. The method also includes filtering search results produced for a particular user search query on the client device using the user search interaction model and the filtration layer.

According to other aspects of the present invention, a computer program product for filtering search engine results for a user is provided. The computer program product includes a non-transitory computer readable storage medium having program instructions embodied therewith. The program instructions are executable by a computer to cause the computer to perform a method. The method includes maintaining, by a hardware processor of the computer, a filtration layer that is opted into by a search engine and a client device. The method further includes building, by the hardware processor, a user search interaction model, operatively coupled to the filtration layer, based on a user's profile and historic search results by performing a topic analysis on a user's interactions with the historic search results and selecting a subset of relevant topics based on respective amounts of user interaction. The user interaction includes interactions on a plurality of different devices. The method further includes filtering search results produced for a particular user search query on the client device using the user search interaction model and the filtration layer.

According to still other aspects of the present invention, a computer processing system for filtering search engine results for a user is provided. The system includes a memory device for storing program code. The system further includes a hardware processor operatively coupled to the memory device for running the program code to maintain a filtration layer that is opted into by a search engine and a client device. The hardware processor further runs the program code to build a user search interaction model, operatively coupled to the filtration layer, based on a user's profile and historic search results by performing a topic analysis on a user's interactions with the historic search results and selecting a subset of relevant topics based on respective amounts of user interaction. The user interaction includes interactions on a plurality of different devices. The hardware processor also runs the program code to filter search results produced for a particular user search query on the client device using the user search interaction model and the filtration layer.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a block diagram of a computing environment, in accordance with an embodiment of the present invention;

FIG. 2 is a flow diagram showing an exemplary method, in accordance with an embodiment of the present invention;

FIG. 3 is a block diagram graphically illustrating block 220 of FIG. 2, in accordance with an embodiment of the present invention;

FIG. 4 is a diagram showing a cosine similarity based distance, in accordance with an embodiment of the present invention;

FIG. 5 is a plot used for pruning, in accordance with an embodiment of the present invention; and

FIG. 6 is a block diagram showing an exemplary system, in accordance with an embodiment of the present invention.

### DETAILED DESCRIPTION

Embodiments of the present invention are directed to a device usage model for search engine content.

Embodiments of the present invention address the problem of better running searches to counter the issue of a term being used in multiple different applications and contexts.

Embodiments of the present invention provide an intelligent abstraction layer system that modifies search engine results and returns articles most related to the context of a user based on device and profile.

The idea is to build up a historical intelligent user/device profile filtration model that acts as an intelligent hidden abstraction layer that sits on top of a search engine. Its goal is to filter out irrelevant, outdated search engine content results returned from the initial search engine based on the combined user and device profile model. The model does not just look at the search term used and compare it to terms in the potential results. The model is also looking at the user's personal history of interaction with past results. This makes for a higher fidelity of solution than existing ones.

Embodiments of the present invention provide the following benefits: outdated websites will no longer be returned; the user will be able to get to the relevant data faster; less back and forth clicks will be needed by the user as the return results will be the most relevant; less time spent searching for information; and less time spent searching by different search strings to try and get the relevant content returned.

Correlation looks to see how closely related one parameter is to another. Correlation does not imply causation. An example of correlation is that for the summer months the sales of ice creams increases. Summer months and sales would be the parameters used to test for correlation. Embodiments of the present invention can look at correlation using a linear regression model. Embodiments of the present invention can be implemented with a linear regression model. The model can form some correlation analysis between the different parameters and weight them based on their correlation value. The model then acts as an intelligent interface that uses the users and devices profile behavior to shorten the amount of pages returned and to return only the most relevant pages to the user.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

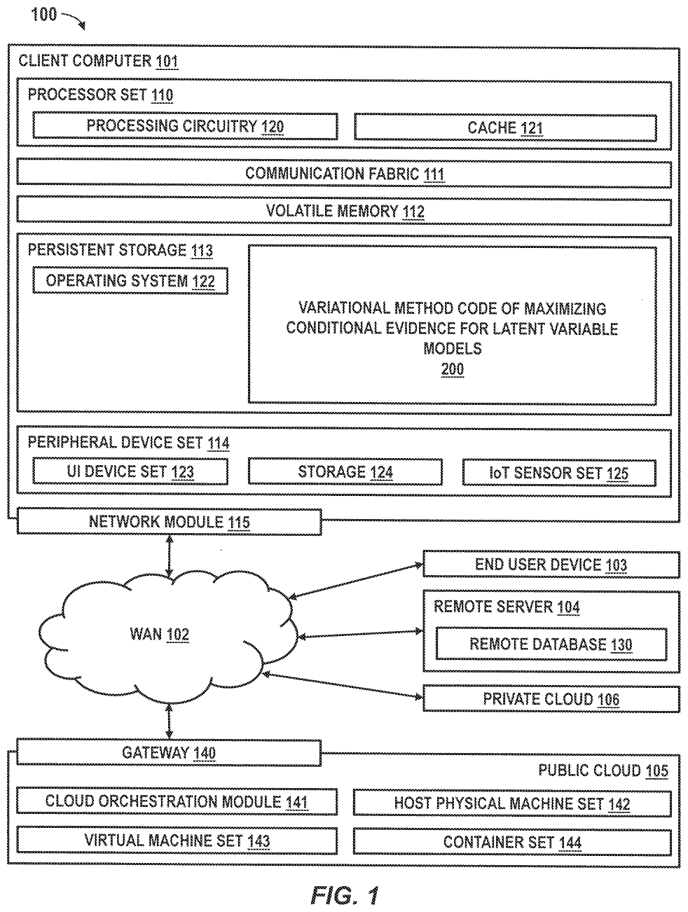

FIG. 1 is a block diagram of a computing environment 100, in accordance with an embodiment of the present invention.

Computing environment 100 contains an example of an environment for the execution of at least some of the computer code involved in performing the inventive methods, such as filtering search engine results 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

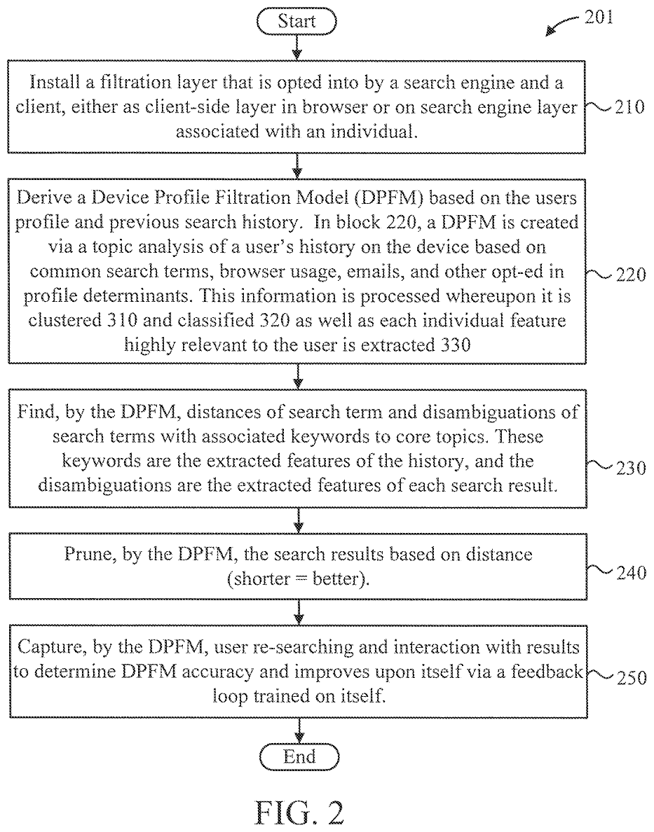

FIG. 2 is a flow diagram showing an exemplary method 200, in accordance with an embodiment of the present invention.

At block 210, install a filtration layer that is opted into by a search engine and a client, either as client-side layer in browser or on search engine layer associated with an individual. This could take the form of a Java script or plugin that can be installed as a browser add-on. It could also be installed at the server layer of a search engine instance.

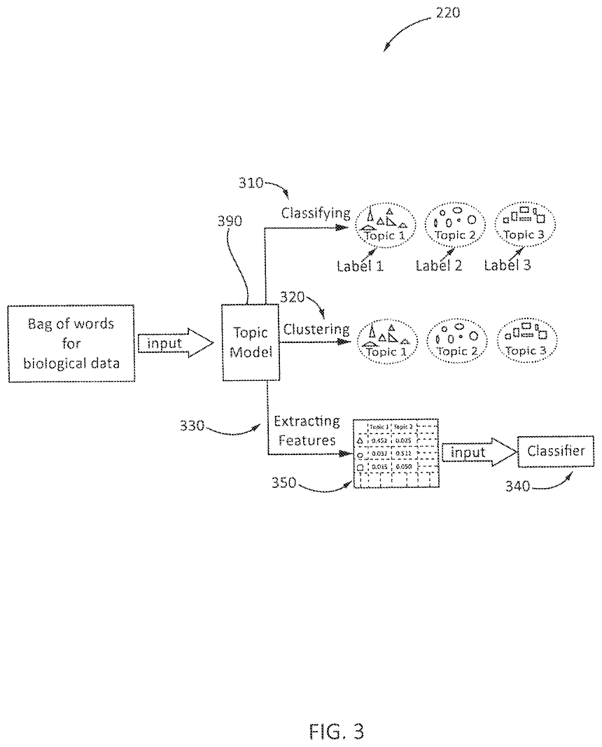

At block 220, derive, a Device Profile Filtration Model (DPFM) based on the users profile and previous search history. In block 220, a DPFM is created via a topic analysis 390 of a user's history on the device based on common search terms, browser usage, emails, and other opt-ed in profile determinants. This information is processed whereupon it is clustered 310 and classified 320 as well as each individual feature highly relevant to the user is extracted 330, as shown in FIG. 3, which is a block diagram graphically illustrating block 220 of FIG. 2, in accordance with an embodiment of the present invention. These features 350 should be indicative of the user and taken. Embodiments of the present invention can utilize Bag of words 301 with Topic Analysis to derive this information. Embodiments of the present invention could also employ Watson Natural Language Understanding Services to pull out keywords, concepts, and entities 350 from a search result page, which would then be fed into the model (classifier) 340. Profile information can include age, gender, nationality, religion, specific interests, hobbies, job, marital status, children status, and so forth.

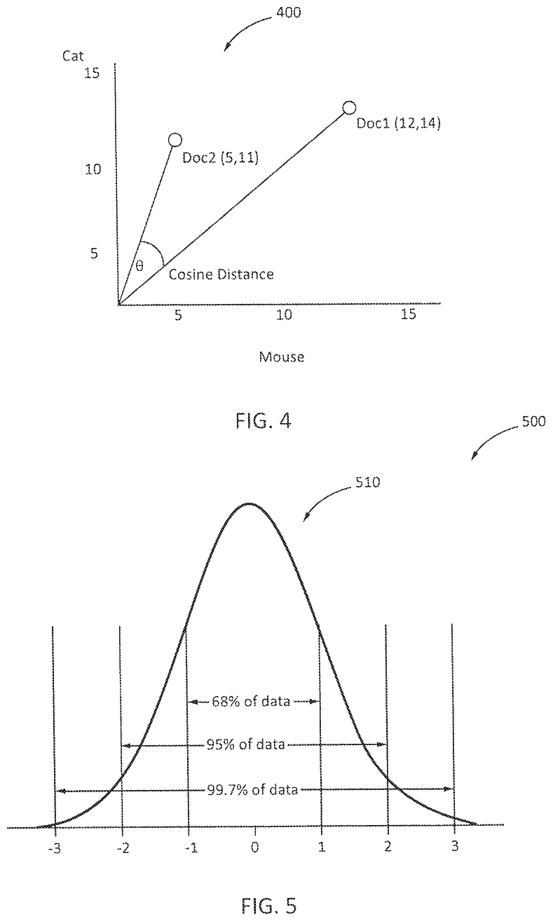

At block 230, find, by the DPFM, distances of search term and disambiguations of search terms with associated keywords to core topics. These keywords are the extracted features of the history, and the disambiguations are the extracted features of each search result. Embodiments of the present invention can do this by running each search result through a process which will find a cosine distance of the search keyword to the concepts and features found within with regards to the source query, as shown in FIG. 4 which is a diagram showing a cosine similarity-based distance 400, in accordance with an embodiment of the present invention. In FIG. 4, the x axis denotes mouse, and the y-axis denotes cat. Two documents are evaluated, a doc1 and a doc2. If the extracted features are similar to ones the user searches and interacts frequently with (e.g., more than a threshold amount), then they will be assigned a shorter distance between the nodes. If it is a very different concept, then the distance will be more different. As an example for illustrative purposes, block 230 will use cosine similarity. As noted, other metrics can be used while maintaining the spirit of the present invention.

At block 240, prune, by the DPFM, the search results based on distance (shorter=better). In block 240, known pruning methods can be used as shown in FIG. 5 including simple removal of nodes/results outside a standard deviation 510 by looking at the standard (z score) of the data returned and pruning anything over 1 z score away at the upper barrier. FIG. 5 is a plot 500 used for pruning, in accordance with an embodiment of the present invention. This pruning will help remove unassociated or loosely associated nodes (search results) while higher associated search results are retained and shown to the user in an ordered manner based off the cosine distance.

At block 250, capture, by the DPFM, user re-searching and interaction with results to determine DPFM accuracy and improves upon itself via a feedback loop trained on itself. In embodiments of the present invention, the model will self-improve upon itself by watching what the user interacts with. If the concepts retrieved are a good fit, the user probably will not retry the search with new keywords. If the concepts retrieved are a poor fit, then the search will be retried with new keywords, and the engine will capture these choices to improve upon itself in future usages and iterations.

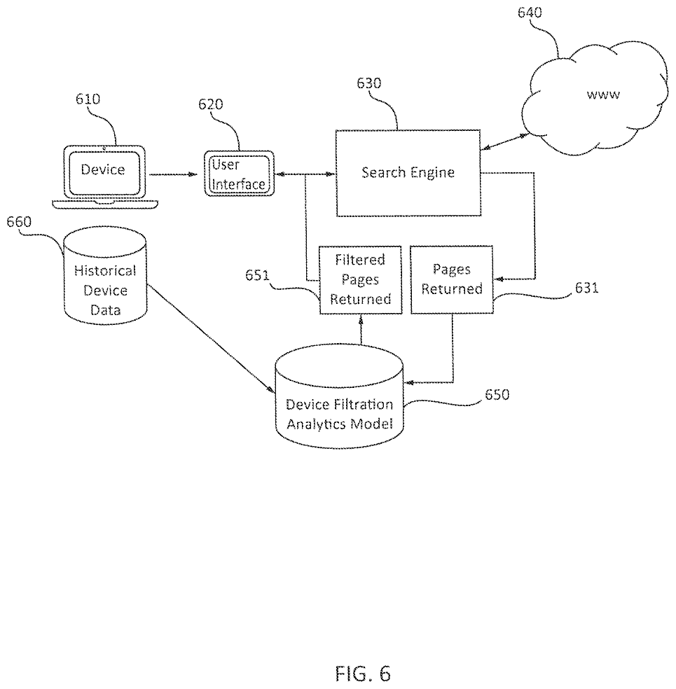

FIG. 6 is a block diagram showing an exemplary system 600, in accordance with an embodiment of the present invention.

The system 600 includes a user device 610, a user interface 620, a search engine 630, the WWW 640, an device filtration analytics model 650, and a historical device data repository 660. The search engine 630 provides pages returned 631, and the model 650 provides filtered pages returned 651.

Thus, an intelligent user/device profile filtration model 650 is required. The model 650 is built based on both a device 610 and users online and offline activity. This activity is monitored, measured, and weighted. The model 650 looks at certain factors and builds up a profile of the user and the device which better understands and refines which of the returned search results are more relevant/appropriate/meaningful to the user based on historical information. The model 650 looks at certain features like for example, but not limited to the following:
Search strings entered;
Similarity of search strings after initial search query;
Pages returned;
Inter arrival time entering the page;
Hyperlinks clicked on;
Hyperlinks ignored;
Back and forth clicks between pages;
Length of time on the page;
Initial search results that do not need a hyperlink click, i.e., the user can see the result without having to open the page—rendered page area size is noted and content inside that area has a better weight than content outside of that area size;
Filtration system to choose to filter by type, i.e., PDF, DOC, DOCX, etc.;
Model that will follow the user from any device; and
Option to turn on and off the filtration. If turned off, it will not use the historical information.

The model weighs all this information and uses the options with the highest probability of success given the historical user behavior and device combinations as described in the model.

The model 650 then acts as an interface 620 between the search engine 630 and the user device 610 and prefilters the return results 631 based on past behavior, as described in the model 650. The end result is a prefiltered set of returned pages 651 that are more specific to the user.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer-implemented method for filtering search engine results for a user, comprising:
maintaining a filtration layer that is opted into by a search engine and a client device;
building a user search interaction model, operatively coupled to the filtration layer, based on a user's profile and historic search results by performing a topic analysis on a user's interactions with the historic search results and selecting a subset of relevant topics based on respective amounts of user interaction, where the user interaction includes interactions on a plurality of different devices; and
filtering search results produced for a particular user search query on the client device using the user search interaction model and the filtration layer.

2. The computer-implemented method of claim 1, wherein the filtration layer is a client-side layer in a client device browser.

3. The computer-implemented method of claim 1, wherein the filtration layer is a search engine layer associated with the user.

4. The computer-implemented method of claim 1, wherein the topic analysis on the user's interactions with the historic search results is based on common search terms, browser usage, emails, and other opt-ed in user profile determinants.

5. The computer-implemented method of claim 1, wherein the common search terms, the browser usage, the emails, and the other opt-ed in user profile determinants are clustered and classified to extract features indicative of the user as represented by the user's profile.

6. The computer-implemented method of claim 1, further comprising, for the particular search query, finding, by the user search interaction model, distances of search terms and disambiguations of the search terms with associated search keywords to the subset of relevant topics.

7. The computer-implemented method of claim 6, wherein the associated keywords are extracted features from the historic search results, and wherein the disambiguations are the extracted features from the current search results.

8. The computer-implemented method of claim 6, wherein finding the distances of the search terms and the disambiguations of the search terms comprises running each of the historic search results through a process which finds a cosine distance of a search keyword to concepts and features found within with the historic search results such that if the extracted features are similar to ones the user searches and interacts with more than a threshold amount, then the extracted features will be assigned a shorter distance with increasing interaction resulting in decreasing distance.

9. The computer-implemented method of claim 1, further comprising capturing, by the user search interaction model, user re-searching and interaction with results to determine model accuracy and improves upon itself via a feedback loop trained on itself.

10. The computer-implemented method of claim 1, wherein search criteria is monitored, measured, and weighted, the search criteria comprising search string entered, similarity of search strings after an initial search query, a number of pages returned, an inter arrival time entering the page, a number of hyperlinks clicked on, a number of hyperlinks ignored, a number of back and forth clicks between pages, and a length of time on a page.

11. A computer program product for filtering search engine results for a user, the computer program product comprising a non-transitory computer readable storage medium having program instructions embodied therewith, the program instructions executable by a computer to cause the computer to perform a method comprising:
maintaining, by a hardware processor of the computer, a filtration layer that is opted into by a search engine and a client device;
building, by the hardware processor, a user search interaction model, operatively coupled to the filtration layer, based on a user's profile and historic search results by performing a topic analysis on a user's interactions with the historic search results and selecting a subset of relevant topics based on respective amounts of user interaction, where the user interaction includes interactions on a plurality of different devices; and
filtering search results produced for a particular user search query on the client device using the user search interaction model and the filtration layer.

12. The computer program product of claim 11, wherein the filtration layer is a client-side layer in a client device browser.

13. The computer program product of claim 11, wherein the filtration layer is a search engine layer associated with the user.

14. The computer program product of claim 11, wherein the topic analysis on the user's interactions with the historic search results is based on common search terms, browser usage, emails, and other opt-ed in user profile determinants.

15. The computer program product of claim 11, wherein the common search terms, the browser usage, the emails, and the other opt-ed in user profile determinants are clustered and classified to extract features indicative of the user as represented by the user's profile.

16. The computer program product of claim 11, further comprising, for the particular search query, finding, by the user search interaction model, distances of search terms and disambiguations of the search terms with associated search keywords to the subset of relevant topics.

17. The computer program product of claim 16, wherein the associated keywords are extracted features from the historic search results, and wherein the disambiguations are the extracted features from the current search results.

18. The computer program product of claim 16, wherein finding the distances of the search terms and the disambiguations of the search terms comprises running each of the historic search results through a process which finds a cosine distance of a search keyword to concepts and features found within with the historic search results such that if the extracted features are similar to ones the user searches and interacts with more than a threshold amount, then the extracted features will be assigned a shorter distance with increasing interaction resulting in decreasing distance.

19. The computer program product of claim 11, further comprising capturing, by the user search interaction model, user re-searching and interaction with results to determine model accuracy and improves upon itself via a feedback loop trained on itself.

20. A computer processing system for filtering search engine results for a user, comprising:
a memory device for storing program code; and
a hardware processor operatively coupled to the memory device for running the program code to:
maintain a filtration layer that is opted into by a search engine and a client device;
build a user search interaction model, operatively coupled to the filtration layer, based on a user's profile and historic search results by performing a topic analysis on a user's interactions with the historic search results and selecting a subset of relevant topics based on respective amounts of user interaction, where the user interaction includes interactions on a plurality of different devices; and
filter search results produced for a particular user search query on the client device using the user search interaction model and the filtration layer.
